(19) United States
(12) Patent Application Publication
(10) Pub. No.: US 2007/0003912 A1
(43) Pub. Date: Jan. 4, 2007

(54) System and method for using colors as a visual communication medium

(76) Inventor: Lee Freedman, Tampa, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(21) Appl. No.: 11/365,116

(22) Filed: Mar. 1, 2006

Related U.S. Application Data
(60) Provisional application No. 60/695,777, filed on Jun. 30, 2005.

(51) Int. Cl. G09B 19/00

(52) U.S. Cl. 434/156

(57) ABSTRACT

A visual communication medium using a sequence of colors visually interpreted as specific words. By altering shape, ideas can be expressed in a one, two, three, or four dimensional mode. One, two, or three languages, stories, or story lines, or any combination of languages and story lines can be expressed at one time. This versatility allows for a full range of expression from convergent unidirectional, unidimensional, unilingual, to multi-directional, multi-dimensional, multi-lingual multi-vergent messages. The set of frequencies used can be changed to suit individual needs as long as the user has a reference band. For wider applications, universal standards are used. These sets should be distinguishable by human or machine visual systems and be reproducible within acceptable tolerances.

### CROSS REFERENCE TO RELATED APPLICATIONS

The present application claims the benefit of previously filed co-pending Provisional Patent Application Ser. No. 60/695,777, filed Jun. 30, 2005, and incorporates by reference the contents therein.

### FIELD OF THE INVENTION

This invention relates to a system and method of communication. In particular, this invention relates to a communication system and method utilizing color sequences to represent specific words to express ideas.

### BACKGROUND OF THE INVENTION

The most widely used current visual communication system is an alphabet text, a system of set shapes. Words, sentences, paragraphs and documents rely on the properties of shape consistency. Current standard writing systems are linear, thus one dimensional, consistently either left to right, right to left, and/or top to bottom. The entire work as well as each section, chapter, page, paragraph, sentence and even word unit is a static, rigid form, without motion. Each unit of understanding, a letter a word or a sentence, is compartmentalized from the next. All units are separated by spaces. This is normally in black forms on a white flat continuous surface. The establishment of an international alphabet has failed in part because the proposed shapes conflict with major current established shaped letterforms. These shapes are inherent to the world's largest cultures, systems such as English, Russian, Arabic, Hebrew, Korean, Japanese, etc.

The physical limitations of letterforms require intact mature developed neurological systems, as well as functioning visual systems. Physiologically, this means the ability to focus, sometimes for long periods of time, an intact retina and optic nerve, as well as the appropriate functioning neuro-centers within the brain. These neuro-centers include but are not limited to those for distinguishing horizontal lines, vertical lines, diagonal lines, curves, and the integration of those lines into complete recognizable shapes. Corresponding letterforms must then be associated as those shapes.

This shape integration process succeeds developmentally the ability to distinguish specific hues, tints, and shades.

The current structure of documents also requires coordinated musculature of the iris, eyeballs and neck and to some extent the ability to turn pages, thus requiring mobility of the upper limbs.

Internal factors such as deviations within these neurological, neuromuscular, optical, or ophthalmologic systems can negatively affect reading. These include but are not limited to various degrees of autism, dyslexia, glaucoma, retinitis pigmentosa, diabetes, myopia, macular degeneration, neuromuscular diseases, muscular dystrophies, aging, and varying levels of paralysis.

External factors such as size, distance, spatial orientation, shape distortion, and the underlying surface's form and texture can all adversely affect the ability to accurately distinguish letterforms. These shape recognition capabilities reside in the human visual system and also in inorganic systems such as optical recognition technologies, scanners and optical character recognition technologies. It is the object of the invention to address the above problems inherent in prior visual communication systems and to supply possible methods of therapy to address these issues.

The following are the prior art systems known to the inventor that use colors in some sense to emphasize letters.

COL'R'TAB, COLOR CODED LABELS by Xertrex International, Inc., Itasca, Ill. These are X-ray jacket sticker labels. They are used to denote initials. The first 8 initials are 8 different solid colors, the second 10 have one white line through them, and the last 8 have two white lines through them. This system is in use currently in some hospitals to label X-ray jackets. It is not intended for writing or reading. Most of the colors are close, which is the reason for the single white bar and the double white bar to distinguish them. The letters they represent are placed on the same label to confirm. All the labels are the same size and shape.

COLORSOUNDS, TEACHING SYSTEM FOR VOWELS. ColorSounds was the name used for a Public TV channel music video teaching tool. The words to the song would scroll along the bottom of the TV screen. Letter or letter combinations representing a single sound appear in the same color while leaving the rest of the text in black. This was intended to teach English as a second language. Only three or four colors were ever used and only one at a time to teach a single phoneme.

WORDS IN COLOR, PRINTED SYSTEM TO TEACH LETTERS. Words in Color was a teaching system from the sixties, last known use in Sarasota, Fla. It was marketed by the Xerox Corporation. Its goal was to teach the English alphabet by using different colors to show the different sounds of a single vowel. Less than 26 colors were used. Its intent was never to create a new system. The goal was to help teach the current shaped letters. Hence, this system is prone to the problems of current alphabet form systems.

Coloring letters for emphasis is in common use. Magnetic refrigerator letters, Sesame Street, even breakfast cereals use some colors to color some letters. None assign unique colors consistently nor are any intended to be read or animated, scanned or transmitted as color-spelled-words or words without any letterform accompaniment. They are intended only to help draw attention to the words or the letters.

No existing communication system assigns unique colors, one for each standard letter form or for single phonemes, nor are any intended to be read, animated, scanned or transmitted as color spelled words. Current systems merely add color to emphasize certain letters, words, or sounds.

### SUMMARY OF THE INVENTION

The current invention is a visual communication medium, referred to herein as “Kromofons”. Kromofons relies on color sequences to determine what that specific word would sound like if spoken. Kromofons is a visual medium that frees up the shape words take thus allowing for these shapes, and the relationship between these shapes, to determine other visual layers of meaning. Kromofons can be used in a first, second, third, or fourth dimensional mode. Shape alteration allows for visual layering within a literary piece. Kromofons can display on different layers multiple languages, multiple stories, multiple story lines, or a combination of languages and story lines. This versatility allows for a full range of fluid expression from convergent unidirectional, unidimensional, unilingual, to multi-vergent multi-directional, multi-dimensional, multi-lingual messages. The Kromofons information delivery system uses the fluid properties of color and light to create the first true animated reading system.

For a fuller understanding of the nature and objects of the invention reference should be made to the following detailed description taken in conjunction with the accompanying figures.

### BRIEF DESCRIPTION OF THE FIGURES

The patent or patent application file contains at least one figure executed in color. Copies of this patent or patent application publication with color drawing(s) will be provided by the Office upon request and payment of the necessary fee. The invention will now be described, by way of example only, with reference to the accompanying figures in which:

FIG. 1 is a page showing an example of Kromofon characters used in a one-dimensional mode read in typical English manner.

FIG. 2 is a poem showing an example of Kromofon characters used in a two dimensional mode.

FIG. 3 shows the two dimensional Kromofon characters of FIG. 2 broken up to show the four individual word layers.

FIG. 4 is an example of Kromofon characters being used to communicate a message in any orientation.

FIG. 5 is crossword puzzle using Kromofon characters.

FIG. 6 is a cell from an animated tunnel sequence of Kromofon characters.

FIG. 7 is an example of Kromofon characters' use on stage.

FIG. 8 shows examples of Kromofon characters in divergent and trivergent unilingual writing.

FIG. 9 shows examples of Kromofon characters in convergent bilingual and trilingual EXIT signs.

FIG. 10 shows a snapshot of multiple animated tunnel sequences of Kromofon characters which could be displayed simultaneously on a computer screen.

FIG. 11 shows morphing consistant Kromofon characters from letter forms to geometric forms as an aid to learning.

### DETAILED DESCRIPTION OF THE INVENTION

The current invention is a visual communication medium, referred to herein as Kromofons. Kromofons relies on color sequences to determine what that specific word would sound like if spoken. Kromofons, as a visual medium, frees up the shape that words take allowing for these shapes and the relationship between those shapes to determine other levels of meaning. Kromofons can be used in a first, second, third, or fourth dimensional mode. Shape alteration allows for visual layering within a literary piece. Kromofons can be used to display multiple languages, multiple stories, multiple story lines, or a combination of languages and story lines. This versatility allows for a full range of expression from convergent unidirectional, uni-dimensional, unilingual, to multi-vergent omni-directional, multi-dimensional, multi-lingual messages.

The set of light frequencies used can be changed to suit individual retinal needs as long as the user has a reference band. For wide application, a universal standard is used. This set should be distinguishable by human and/or machine optical visual systems and be reproducible within human visual tolerances. This specification explains one embodiment using a set of light frequencies in CMYK terms since the figures are in print. Of course, as those skilled in the art will immediately recognize, their equivalents in RGB, LAB, HSL, pantone inks, paint numbers, textiles, dyes, physical materials from glass to brick used in the arts or in products manufactured as well as naturally occurring physical objects, as long as they transmit or reflect color, could also be used in various applications of this system.

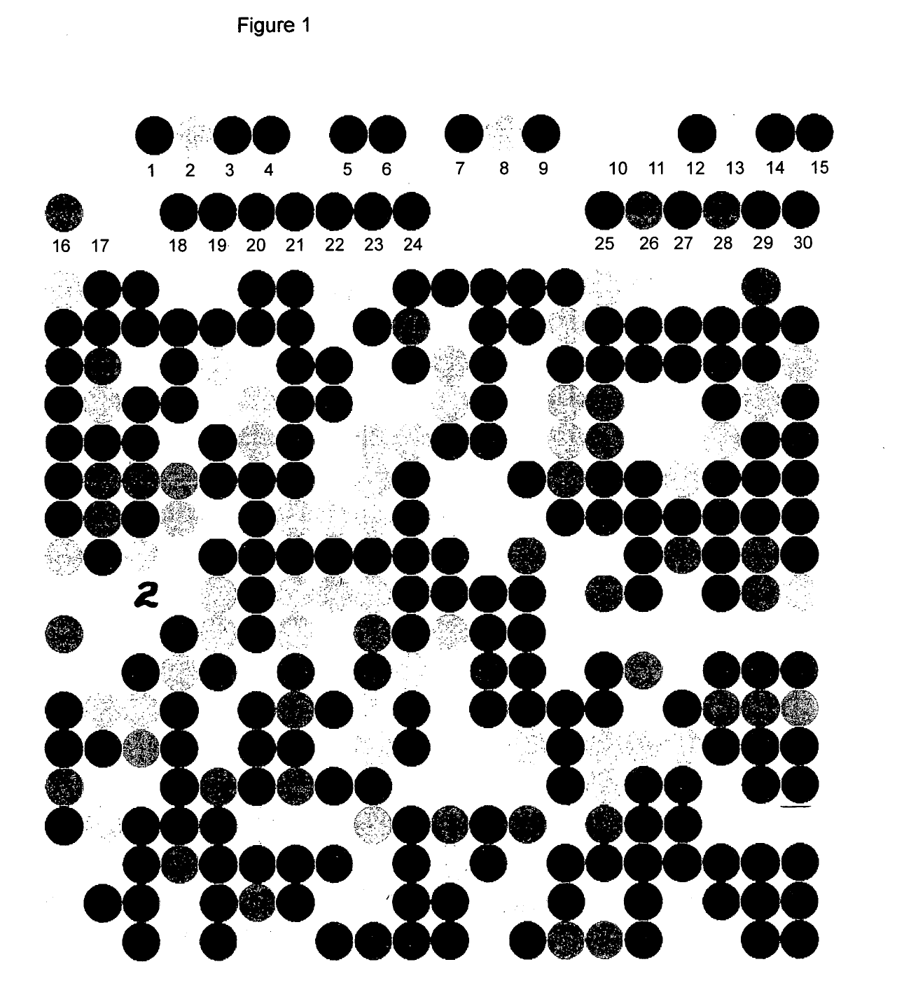

FIG. 1 is an example of one dimensional writing using only Kromofons. It is a page of text that might appear in a typical book, novel, newspaper, or magazine. It is read like current standard text, left to right, and top to bottom. The first word “THIS” consists of four Kromofons in the form of circles. Circle #1 is the character “T”: it is made up of the CMYK colors: 0% cyan, 100% magenta, 0% yellow, 0% black. It is identical to circles 7, 12, and, 21. Circle #2 is the character “H”: it is made up of the CMYK colors: 0% cyan, 15% magenta, 94% yellow, 0% black. It is identical to circles 8. Circle #3 is the character “I”: it is made up of the CMYK colors: 100% cyan, 0% magenta, 65% yellow, 0% black. It is identical to 5, 20, and 22. Circle #4 is the character “S”: it is made up of the CMYK colors: 100% cyan, 0% magenta, 0% yellow, 0% black. It is identical to 6 and 30.

The second word “IS” consists of two Kromofon characters. Circle #5 is the character “I”: it is made up of the CMYK colors: 100% cyan, 0% magenta, 65% yellow, 0% black. It is identical to 3, 20, and 22. Circle #6 is the character “S”: it is made up of the CMYK colors: 0% cyan, 80% magenta, 40% yellow, 0% black. It is identical to 4 and 30.

The third word “THE” consists of three Kromofon characters. Circle #7 is the character “T”: it is made up of the CMYK colors: 0% cyan, 100% magenta, 0% yellow, 0% black. It is identical to 1, 12, and 21. Circle #8 is the character “H”: it is made up of the CMYK colors: 0% cyan, 15% magenta, 94% yellow, 0% black. It is identical to 2. Circle #9 is the character “E”: it is made up of the CMYK colors: 0% of cyan, 51% of magenta, 87% of yellow, 0% of black. It is identical to 15.

The fourth word “FUTURE” consists of six Kromofon characters. Circle #10 is the character “F”: it is made up of the CMYK colors: 0% cyan, 12% magenta, 19% yellow, 0% black. It is identical to 17. Circle #11 is the character “U”: it is made up of the CMYK colors: 0% cyan, 0% magenta, 100% yellow, 0% black. It is identical to 13. Circle #12 is the character “T”: it is made up of the CMYK colors: 0% cyan, 100% magenta, 0% yellow, 0% black. 12. It is identical to 1, 7, and 21. Circle #13 is the character “U”: it is made up of the CMYK colors: 0% cyan, 0% magenta, 100% yellow, 0% black. It is identical to 11. Circle #14 is the character “R”: it is made up of the CMYK colors: 0% cyan, 91% magenta, 100% yellow, 23% black. It is identical to 19 and 29. Circle #15 is the character “E”: it is made up of the CMYK colors: 0% cyan, 51% magenta, 87% yellow, 0% black. It is identical to 9.

The fifth word “OF” consists of two Kromofon characters. Circle #16 is the character “O”: it is made up of the CMYK colors: 0% cyan, 9% magenta, 15% yellow, 43% black. It is identical to 26 and 28. Circle #17 is the character “F”: it is made up of the CMYK colors: 0% cyan, 12% magenta, 19% yellow, 0% black. It is identical to 10.

The sixth word “WRITING” consists of seven Kromofon characters. Circle #18 is the character “W”: it is made up of the CMYK colors: 0% cyan, 15% magenta, 34% yellow, 60% black. Circle #19 is the character “R”: it is made up of the CMYK colors: 0% cyan, 91% magenta, 100% yellow, 23% black. It is identical to 14 and 29. Circle #20 is the character “I”: it is made up of the CMYK colors: 100% cyan, 0% magenta, 65% yellow, 0% black. It is identical to 3, 5, and, 22. Circle #21 is the character “T”: it is made up of the CMYK colors: 0% cyan, 100% magenta, 0% yellow, 0% black. It is identical to 1, 7, and, 12. Circle #22 is the character “I”: it is made up of the CMYK colors: 100% cyan, 0% magenta, 65% yellow, 0% black. It is identical to 3, 5, and, 20. Circle #23 is the character “N”: it is made up of the CMYK colors: 76% cyan, 0% magenta, 100% yellow, 23% black. Circle #24 is the character “G”: it is made up of the CMYK colors: 100% cyan, 0% magenta, 0% yellow, 51% black.

The extended space that appears after the word WRITING is used to indicate the end of one sentence and the beginning of the next. Traditional punctuation can be used or the last Kromofon color can be shaped like a period. Strategies for punctuation vary with the creator. There may be size differentials or spatial boundaries between sentences or paragraphs; or any other artistic function used to break up a space.

The next sentence begins with the seventh word “COLORS”. It consists of six Kromofon characters. Circle #25 is the character “C”: it is made up of the CMYK colors: 0% of cyan, 56% of magenta, 6% of yellow, 0% of black. Circle #26 is the character “O”: it is made up of the CMYK colors: 0% cyan, 9% magenta, 15% yellow, 43% black. It is identical to 16 and 28. Circle #27 is the character “L”: it is made up of the CMYK colors: 0% cyan, 91% magenta, 87% yellow, 0% black. Circle #28 is the character “O”: it is made up of the CMYK colors: 0% cyan, 9% magenta, 15% yellow, 43% black. It is identical to 16 and 26. Circle #29 is the character “R”: it is made up of the CMYK colors: 0% cyan, 91% magenta, 100% yellow, 23% black. It is identical to 14 and 19. Circle #30 is the character “S”: it is made up of the CMYK colors: 100% cyan, 0% magenta, 0% yellow, 0% black. It is identical to 4 and 6.

The first seven words of this text read: “THIS IS THE FUTURE OF WRITING COLORS”

The entire page shown, if completely conveyed to standard letters forms reads

THIS IS THE FUTURE
OF WRITING COLORS
ARE USED INSTEAD OF
LETTERS TO REPRESENT
SOUND IN THE ENGLISH
LANGUAGE AS YOU CAN
SEE THE PAGE YOU ARE
LOOKING AT CONTAINS
BOTH SHAPED LETTERS
AND CIRCLES OF COLOR

2 ALPHABETS ON TOP

OF EACH OTHER

THE IDEA IS TO SEE

WHAT WORDS WILL LOOK

LIKE IN AN ALPHABET
OF COLORS THIS IS
CALLED KROMOFONS

NOTICE THE LETTERS

ARE NOT ALWAYS THERE

THEY WILL SOON ALL

New forms of media at first fulfill some of the properties of the medium that it supersedes. FIG. 1 is an example of what a typical page of Kromofons text would look like on a computer monitor or a printed page. By appearing in a form that is recognizable to the general public, it allows the average person to comprehend the similarities in the two mediums in order to make a smoother transition.

Circles present no difficulty in shape recognition for some forms of dyslexia that have problems with mirrored letter shapes such as db, qp, mw, sz. Standard text is more dependent on fine focus than color recognition is. Thus viewing color reduces eyestrain caused by reading for extended periods at one sitting. Eyestrain is even greater for those individuals who require corrective lenses. Viewing color may also be used in therapy for other vision or physical movement maladies.

Color can be identified at greater distances than comparably sized alphabet shapes. Road signs currently utilize this feature. Kromofons can thus be used for billboards and road signs.

Kromofons presents a new form of communication that is entertaining for the viewer. Currently, the world alphabets lack visual stimulation, the images created by the written words are maintained in the mind of the reader. Kromofons could add direct visual imagery of the word itself. This additional use of the visual senses intensifies the reading experience for the viewer. Reading becomes more enjoyable, stimulating, and thus easier to use as a learning tool.

This feature can be used to teach reading at an earlier age, in another language, or to an illiterate. The added visual ques create more object beams for easier memory storage within the framework of the holographic model of human memory.

Acquiring new information is directly proportional to one's reading speed. Color recognition can be accomplished by a neural network using as few as three neurons. Since letters use horizontal, vertical, diagonal, and curved lines, they require as few as nine and as many as 20 synaptic junctions for their recognition. Color identification is quicker and requires less biochemical energy. Comprehension has been shown to increase with the speed of reading. Since Kromofons as a delivery system can be read faster, a Kromofons viewer is capable of greater comprehension in a shorter time period.

Three year olds, while still having difficulty with their a, b, c shapes, have much less difficulty with their red, yellow, and blues, assuming they are not colorblind. While no one has yet done a large study specifically teaching Kromofons, it is reasonable to assume that reading could be taught to a youngster who has acquired color differentiation but has not yet mastered all the intricacies required to distinguish letterforms.

Memory studies show that a group of facts connected together in a picture will be retained easier and for longer periods of time than a group of facts presented by using text alone. The ability of Kromofons to present text in a picture form can use this memory strategy to a much greater extent that any existing current alphabet structure.

Current optical character recognition systems used with scanners have the ability to ‘read’ from 0-100% accuracy depending on the font, contrast, and clarity of the page of text. Typical problems include the ‘d’ being mistaken for a ‘c’ and an ‘l’. Color densitometer scanning devices with the proper software to optically read Kromofon text should approach 100% accuracy.

Another use is skywriting. Currently a highly skilled pilot, performing complicated maneuvers is required for each letter, thus skywriting can only present short messages. Kromofons, using a single stream and multiple exhaust dyes can present whole sentences in less space, with less skill, in a shorter period of time. This also eliminates the variables of high altitude winds destroying shapes, which in turn increases message time.

For the highly creative chefs of the world, Kromofons offers the opportunity to combine their culinary skill with artistic acumen to produce decorative desserts that are the message, from wedding cakes to theme pies. Although cake makers can easily spell words now, there is a limited amount of space that precludes long messages, especially with the addition of decorative icing, flowers, and candles. Kromofon colored candles encircling the top of the cake could easily contain the message without decreasing the surface area, leaving room for a second message in colored flowers. Multiple messages can be displayed with the use of different shaped decorations that are dyed in the appropriate sequences.

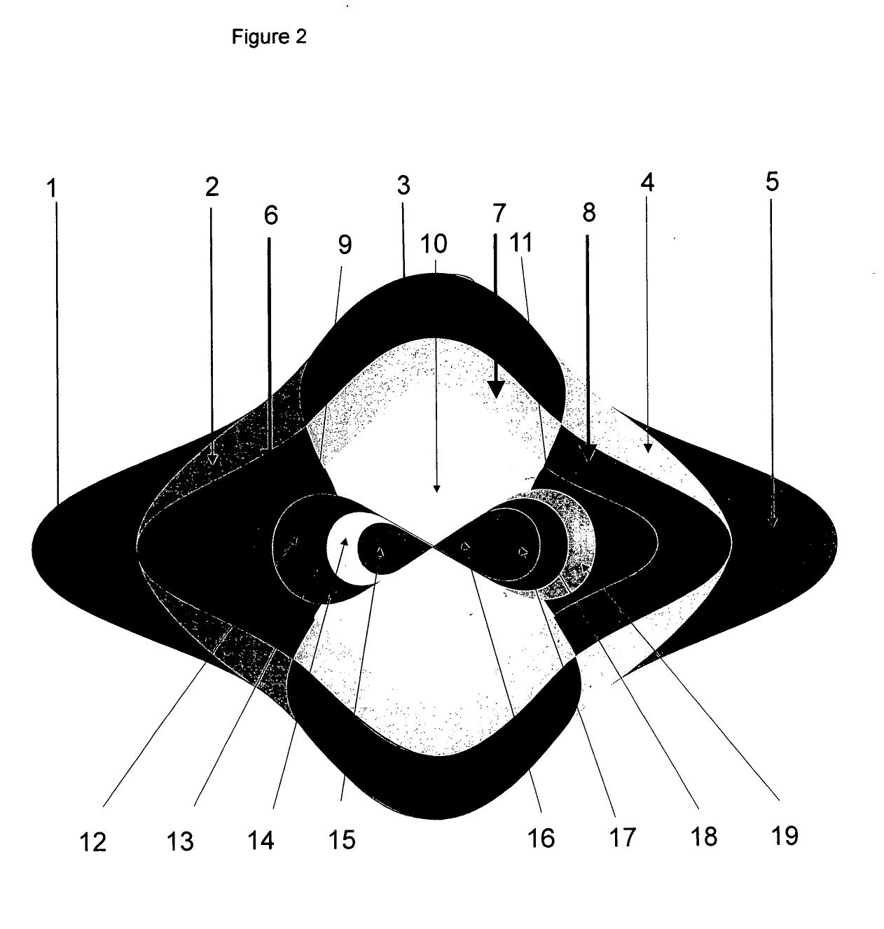

FIG. 2 is an example of two dimensional writing. With Kromofons words no longer need be read in a particular order. Kromofons is naturally suited for the literary form known as poetry because it can utilize the artistic potentials of fluid writing. Our civilization is based on linear thought derived from linear speech and linear writing. Thus forms of one dimensional thought can be written one word after the next. But some thoughts are not linear. Two dimensional Kromofons allows for the visual representation of complex thoughts that rely on the relationships between thoughts and ideas that cannot be spoken in a linear format.

FIG. 2 actually depicts a poem. Each layer of the poem represents a single word. There are four words in this poem, read from outside in, these are WOMAN, MAN, LUV, INFINITY. A different interpretation can be arrived at if these words are viewed from the inside out.

Because Kromofons does not need a specific orientation, the words are read traditionally left to right when the label of this drawing is at the top. The words are read from top to bottom when the drawing label appears on the right. The words are read from right to left when the drawing label is on the bottom. This scheme can be followed ad infinitum as the poem is rotated.

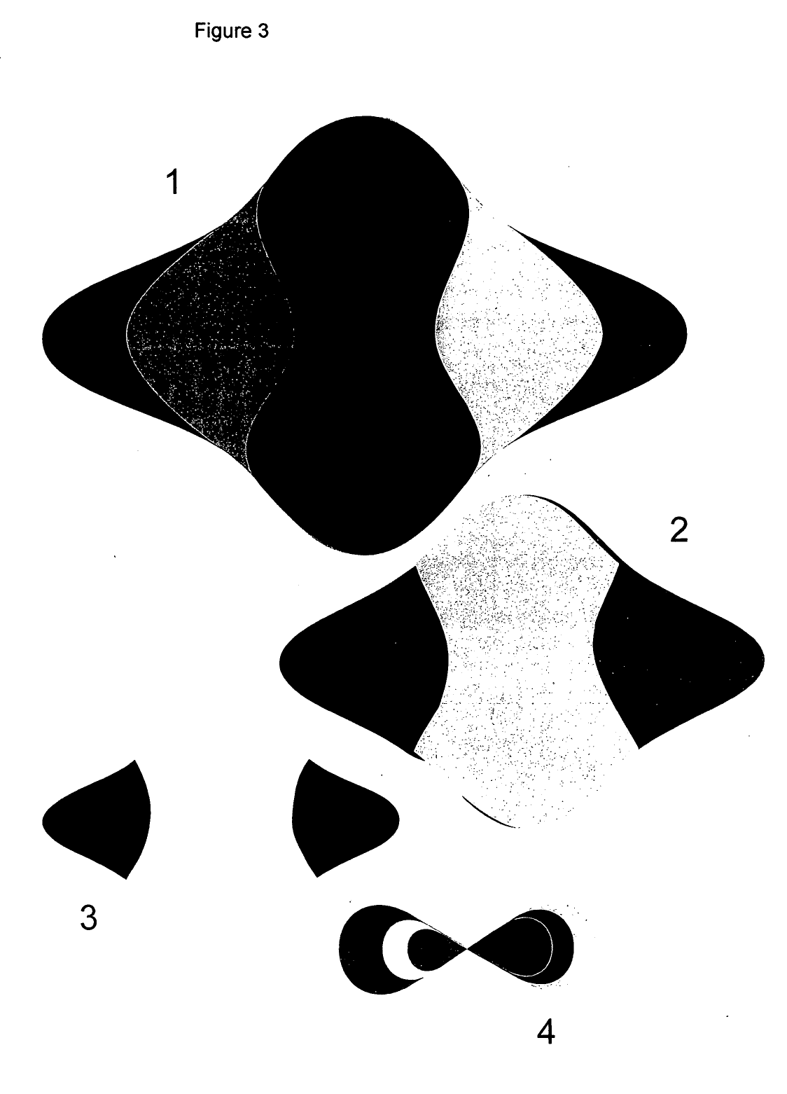

The outer layer is the word “WOMAN” and is made up of five Kromofon characters. It is shown by itself in FIG. 3, labeled number 1. This word is made up of 5 areas. Area #1 is the character “W”: it is made up of the CMYK colors: 0% cyan, 15% magenta, 34% yellow, 60% black. Area #2 is the character “O”: it is made up of the CMYK colors: 0% cyan, 9% magenta, 15% yellow, 43% black. Area #3 is the character “M”: it is made up of the CMYK colors: 0% cyan, 94% magenta, 34% yellow, 28% black. It is identical to 6. Area #4 is the character “A”: it is made up of the CMYK colors: 0% cyan, 0% magenta, 100% yellow, 19% black. It is identical to 7. Area #5 is the character “N”: it is made up of the CMYK colors: 76% cyan, 0% magenta, 100% yellow, 23% black. It is identical to 8, 13, and 16.

The second layer is just inside the outer most layer. It is the word “MAN” made up of three Kromofon characters. It is shown by itself in drawing #3, labeled 2 with the following colored areas. Area #6 is the character “M”: it is made up of the CMYK colors: 0% cyan, 94% magenta, 34% yellow, 28% black. It is identical to 3. Area #7 is the character “A”: it is made up of the CMYK colors: 0% cyan, 0% magenta, 100% yellow, 19% black. It is identical to 4. Area #8 is the character “N”: it is made up of the CMYK colors: 76% cyan, 0% magenta, 100% yellow, 23% black. It is identical to 5, 13, and 16.

The next layer inside is the word “LUV”. It is made up of three Kromofon characters. It is shown by itself in drawing #3, labeled 3. It is made up of the following areas. Area #9 is the character “L”: it is made up of the CMYK colors: 0% cyan, 91% magenta, 87% yellow, 0% black. Area #10 is the character “U”: it is made up of the CMYK colors: 0% cyan, 0% magenta, 100% yellow, 0% black. Area #11 is the character “V”: it is made up of the CMYK colors: 100% cyan, 79% magenta, 0% yellow, 0% black.

The fourth layer, which is in the shape of an infinity sign, lies in the most interior layer of the painting. It is the word, “INFINITY”. If viewed from a different perspective it could appear to be the top most layer. It is shown by itself in Drawing #3, labeled 4. In this word area #12 is the character “I”: it is made up of the CMYK colors: 100% cyan, 0% magenta, 65% yellow, 0% black. It is identical to 15 and 17. Area #13 is the character “N”: it is made up of the CMYK colors: 76% cyan, 0% magenta, 100% yellow, 23% black. It is identical to 5, 8, and 16. Area #14 is the character “F”: it is made up of the CMYK colors: 0% cyan, 12% magenta, 19% yellow, 0% black. Area #15 is the character “I”: it is made up of the CMYK colors: 100% cyan, 0% magenta, 65% yellow, 0% black. It is identical to 12 and 17. Area #16 is the character “N”: it is made up of the CMYK colors: 76% cyan, 0% magenta, 100% yellow, 23% black. It is identical to 5, 8, and 13. Area #17 is the character “I”: it is made up of the CMYK colors: 100% cyan, 0% magenta, 65% yellow, 0% black. It is identical to 12 and 15. Area #18 is the character “T”: it is made up of the CMYK colors: 0% cyan, 100% magenta, 0% yellow, 0% black. Area #19 is the character “Y”: it is made up of the CMYK colors: 38% cyan, 0% magenta, 38% yellow, 0% black.

These four layers: “WOMAN”, “MAN”, “LUV”, and “INFINITY”, together visually have multiple interpretations one of which is that when man is inside woman, only through love can they reach infinity.

The same poem can be made three dimensional by using computer modeling programs, or can be painted onto a sculpture using the same or different design. Full 3-D writing can even be shown with extreme depth using holograms, animated film, or even in a series of objects as diverse as kites, parachutes, hot air balloons, or sand. While the same four words in current text remain unchanged visually, Kromofon poetry has the option of creating entire poetic landscapes, changing the artistic literary thrust of the poetic image.

Kromofons allows the combining of art and literature to form new literary mediums limited only by the creativity of the author-artist.

Also, the current system of rigid shaped characters makes it difficult to label personal property without defacing its artistic value. Kromofons allows property to be labeled in such a manner that the appearance of the object need not be compromised. Striping tennis racket handles allows the label to be readable, regardless of the orientation of the racket. Placing information and labels on items can ruin the artistic appearance of the item. Kromofons allows data to be added to items without destroying their visual appearances.

Current writing systems require a flat, contiguous surface of sizable dimensions. Objects that can be labeled that lack this sufficiency in being either flat, continuous or having a sizable surfaces include: balloons, hot air balloons, string, candles, dinner ware, utensils, curtains, shower curtains, clocks, pottery, concrete, stained glass, food, flowers, frostings, cakes, T-shirts, arrows, cars, pinstripe decals, decals, boxes, clothes, rugs, wallpaper, tattoos, costumes, tape, soap dishes, glasses, cups, costumes, packaging, instruments, cabinets, doors, windows, signs, roofing, siding, bricks, ceramics, logos, paintings, lithographs, poles, jewelry, footwear, umbrellas, briefcases, lunch boxes, luggage, musicals, matting, frames, street art, rubber stamps, tile, crayons, furniture, upholstery, gloves, hats, novelty items, seat covers, toys, colorforms, doll clothes, athletic wear, lampshades, containers, watches, barrettes, school yard games, surf boards, trucks, vans, boats, planes, pens, rapidograph, buttons, indicators, masks.

Items that do have flat continuous surfaces but need to retain certain artistic consistency can be labeled with Kromofons, and include: envelopes, notebooks, stationary, greeting cards, folders, CD and DVD covers, paper, billboards, publications, advertisements, book jackets, signs, stickers, letters, press-ons, tags, and bulletin boards.

The following items are mediums of color: hair dyes, clothing dyes, food dyes, paint, inks, pencils, glazes, stains, filters, stage lighting, make-up, nail polish, printing ribbons, crayons, chalks, cray-pas, LASERS, and acrylics. They can be used in conjunction with Kromofons to label items that are not traditionally thought of as having labels or messages such as fingernails, or hair.

Current alphabets are limited in their ability to communicate because they are linear and rigid. Kromofons enables new forms of nonlinear fluid expression. In one extreme objects that lack flat contiguous surfaces, such as: spokes of a bicycle wheel, antenna, poles, wires, pillars, shelf edges, car pin-striping, hat brims, control knobs, door knobs, eyeglass frames, and athletic equipment can now be used as mediums of communication.

Artists utilize a wide variety of methods to communicate their ideas. Kromofons presents a radically new approach to the expressing of ideas by combining art and literature in heretofore impossible combinations and relationships. The very fact that new forms of art will be developed allows the creator to communicate new ideas, new concepts, and new thoughts that are not currently possible. The ability to combine visual aspects of artistic expression with linguistics, expands the message possibilities of the artist, writer, animator, designer, digital artist, poet, novelist, painter, stain glass artist, sculptor, web designer, holographer, or cinematographer.

The flip side of this is that the recipient, viewer, reader, interpreter, consumer, or art connoisseur of these new expressions will perceive thought in form and manner previously not available or conceived of. This must lead to new neuropathways of thought and comprehension. Over the course of generations, this could lead to a new culture. All alphabets can be transmorphed into Kromofons thus helping to shorten the process of creating a world culture.

Rigid shaped letters of current alphabets limit the effectiveness of intended messages on objects of unusual shapes. Kromofons eliminates reliance on an object's shape for deploying and displaying messages. Designers can create new lines of toys, novelties, word, board and online games.

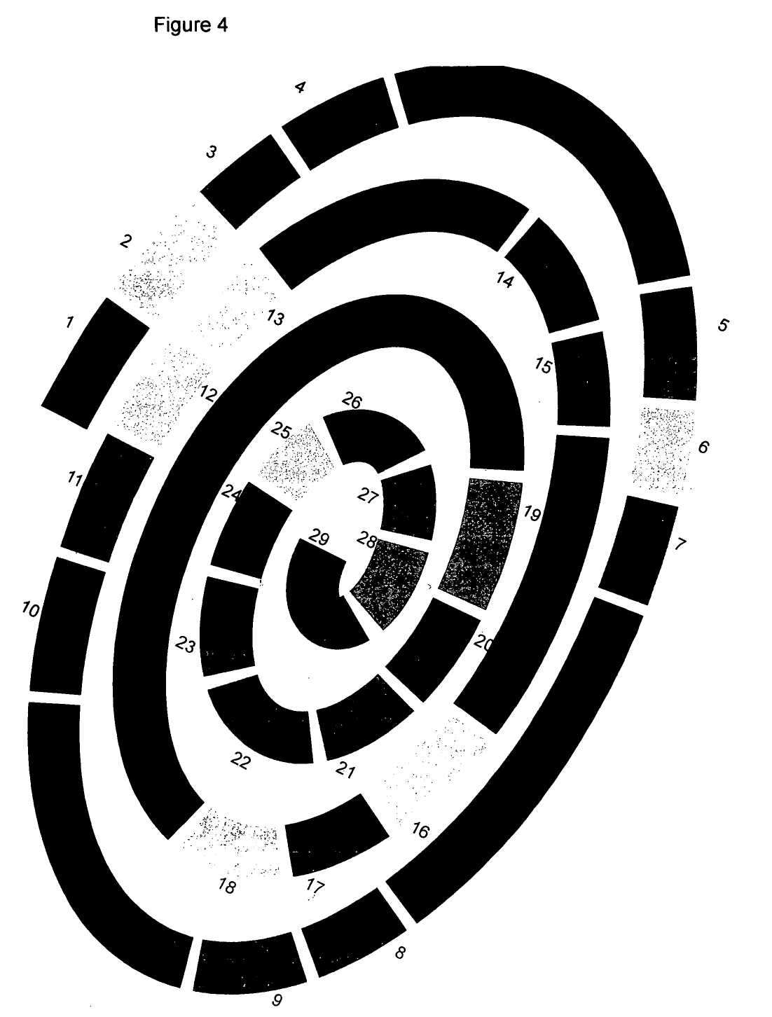

FIG. 4 shows a snake-shaped sentence spiraling inward. It displays Kromofons' ability to be read in any orientation. Each English word is a set of consecutively filled Kromofon character blocks. Black areas indicate spaces between words. Alternatively each block could be filed with a single Kromofon word, thus making each series into a sentence, and the entire spiral now becomes a paragraph.

The first word “THIS” has four Kromofon blocks labeled 1-4. 1. This character: “T” is made of the CMYK colors of: 0% of cyan, 100% of magenta, 0% of yellow, 0% of black. It is identical to 30 and 32. 2. This character: “H”: it is made up of the CMYK colors: 0% cyan, 15% magenta, 94% yellow, 0% black. 3. This character: “I”: it is made up of the CMYK colors: 100% cyan, 0% magenta, 65% yellow, 0% black. It is identical to 18, 27, and 33. 4. This character: “S” is made of the CMYK colors of: 100% of cyan, 0% of magenta, 0% of yellow, 0% of black. The next block is black to show a word break. It is identical to 9, 12, 17, 20, and 24.

The second word “CAN” has three Kromofon blocks labeled 5-7. 5. This character: “C” is made of the CMYK colors of: 0% of cyan, 56% of magenta, 6% of yellow, 0% of black. 6. This character: “A” is made of the CMYK colors of: 0% cyan, 0% magenta, 100% yellow, 19% black. It is identical to 15, 21, and 31. 7. This character: “N” is made of the CMYK colors of: 76% cyan, 0% magenta, 100% yellow, 23% black. It is identical to 19, 22, 29, and 35. The next block is black to show a word break. It is identical to 5, 12, 17, 20, and 24.

The third word “BE” has two Kromofon blocks labeled 8 and 9. 8. This character: “B” is made of the CMYK colors of: 23% of cyan, 56% of magenta, 0% of yellow, 0% of black. 9. This character: “E” is made of the CMYK colors of: 0% of cyan, 51% of magenta, 87% of yellow, 0% of black. It is identical to 14 and 28. The next block is black to show a word break. It is identical to 5, 9, 17, 20, and 24.

The fourth word “READ” has four Kromofon blocks labeled 10-13. 10. This character: “R” is made of the CMYK colors of: 0% cyan, 91% magenta, 100% yellow, 23% black. It is identical to 26. 11. This character: “E” is made of the CMYK colors of: 0% of cyan, 51% of magenta, 87% of yellow, 0% of black. It is identical to 11 and 28. 12. This character: “A” is made of the CMYK colors of: 0% cyan, 0% magenta, 100% yellow, 19% black. It is identical to 7, 21, and 31. 13. This character: “D” is made of the CMYK colors of: 28% of cyan, 0% of magenta, 12% of yellow, 0% of black. The next block is black to show a word break. It is identical to 5, 9, 12, 20, and 24.

The fifth word “IN” has two Kromofon blocks labeled 14 and 15. 14. This character: “I”: it is made up of the CMYK colors: 100% cyan, 0% magenta, 65% yellow, 0% black. It is identical to 3, 27, and 33. 15. This character: “N” is made of the CMYK colors of: 76% cyan, 0% magenta, 100% yellow, 23% black. It is identical to 8, 22, 29, and 35. The next block is black to show a word break. It is identical to 5, 9, 12, 17, and 24.

The sixth word “ANY” has three Kromofon blocks labeled 16-18. 16. This character: “A” is made of the CMYK colors of: 0% cyan, 0% magenta, 100% yellow, 19% black. It is identical to 7, 15, and 31. 17. This character: “N” is made of the CMYK colors of: 76% cyan, 0% magenta, 100% yellow, 23% black. It is identical to 8, 19, 29, and 35. 18. This character: “Y” is made of the CMYK colors of: 38% cyan, 0% magenta, 38% yellow, 0% black. The next block is shaded with black to show the word break. It is identical to 5, 9, 12, 17, and 20.

The seventh word “ORIENTATION” has eleven Kromofon blocks labeled 19-29. 19. This character: “O” is made of the CMYK colors of: 0% of cyan, 9% of magenta, 15% of yellow, 43% of black. It is identical to 34. 20. This character: “R” is made of the CMYK colors of: 0% cyan, 91% magenta, 100% yellow, 23% black. It is identical to 13. 21. This character: “I” is made up of the CMYK colors: 100% cyan, 0% magenta, 65% yellow, 0% black. It is identical to 3, 18, and 33. 22. This character: “E” is made up of the CMYK colors of: 0% of cyan, 51% of magenta, 87% of yellow, 0% of black. It is identical to 11 and 14. 23. This character: “N” is made of the CMYK colors of: 76% cyan, 0% magenta, 100% yellow, 23% black. It is identical to 8, 19, 22, and 35. 24. This character: “T” is made of the CMYK colors of: 0% of cyan, 100% of magenta, 0% of yellow, 0% of black. It is identical to 1 and 32. 25. This character: “A” is made of the CMYK colors of: 0% cyan, 0% magenta, 100% yellow, 19% black. It is identical to 7, 15, and 21. 26. This character: “T” is made of the CMYK colors of: 0% of cyan, 100% of magenta, 0% of yellow, 0% of black. It is identical to 1 and 30. 27. This character: “I”: it is made up of the CMYK colors: 100% cyan, 0% magenta, 65% yellow, 0% black. It is identical to 3, 18, and 27. 28. This character: “O” is made of the CMYK colors of: 0% of cyan, 9% of magenta, 15% of yellow, 43% of black. It is identical to 25. 29. This character: “N” is made of the CMYK colors of: 76% cyan, 0% magenta, 100% yellow, 23% black. It is identical to 8, 19, 22, and 29.

These seven English words are depicted with Kromofon filled blocks. Read from the outside in, the message reads: “THIS CAN BE READ IN ANY ORIENTATION”. FIG. 4 shows that Kromofons has the capability of expression in any orientation. Current English writing systems can only be read in one direction: from left to right and top to bottom. Kromofons is unrestricted by the rigid confines of standard letterform conventional text because it does not rely on shape as its primary conveyor of information.

There are many forms of dyslexia. The most common form entails misidentifying mirror shaped letters such as the b and d; and spelling words backwards, such as tab for bat. One of the main reasons for this is that a black and white, left to right, top to bottom page of text lacks sufficient clues and queues. Kromofons allows the writer to eliminate straight line text and top to bottom page orientation, while gaining the ability to add visual clues within words such as decreasing the height of a word from its beginning to its end, using directional clues, shaping the entire word in a unique manner, orienting words, phrases, sentences, or entire paragraphs, and creating and using the spatial relationship between letters, sentences, paragraphs, and even entire pages. Kromofons presents new options for systems previously unavailable to educators and physical therapists. Since it is a new medium, exact visual strategies needed for each type of dyslexia have yet to be developed.

Freeing up shape allows for shape strategies to be used as second and third layers of information. Kromofons gives added tools not currently available to the communicator and the educator.

Similar strategies can also be used for increased memory retention and verbal comprehension. The addition of color stimulates the brain and the mind in a different manner than that of standard, black and white, rigid letterforms. These extra thought processes may train the mind to operate better, increasing memory retention or rehabilitating the injured brain.

Writing no longer dominates the way most information is presented for reading and comprehension. Computers now represent the primary tool of writing systems. The use of new software tools eases the production of 2-D, 3-D, and animated writing. Orientation of text is currently a left to right, top down format. Using any other orientation creates difficulties for the reader in interpreting the intended message. Kromofons releases the creator ad viewer from the confines of one-dimensional thing, allowing information to be depicted in any orientation.

FIG. 4 shows how Kromofons can be used in a circular pattern. Unlike standard letter shapes, which require certain spatial relations and orientation to surrounding letters, viewers encounter no difficulty in recognizing the color of the Kromofons character, and thus are able to understand the message despite its non-standard orientation. This method of writing can be applied to usually shaped objects such as: wires, poles, shelf edges, bottle tops, door knobs, CD's, DVD's, records, round tables, Frisbees, plates, dishes, cans, bottles, balls, golf clubs, etc.

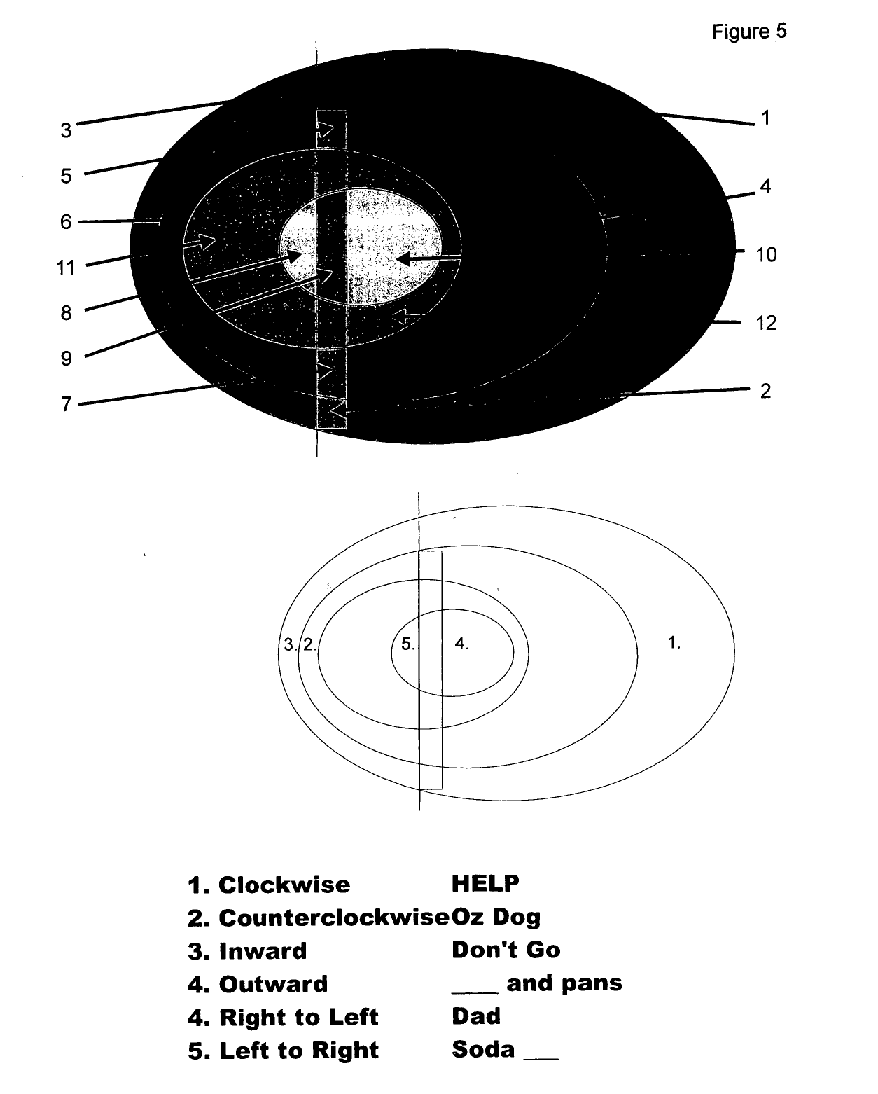

FIG. 5 is an example of Kromofons used in a word search. It shows that Kromofons can be used to create new games and puzzles or to create new variations on old games and puzzles. The reader can find the following words or phrases: SOS, Stop, Pots, Pop, and Toto as explained herein. 1. This area is filled with the Kromofon “S”, which is made of the CMYK colors of: 100% of cyan, 0% of magenta, 0% of yellow, and 0% of black. It is identical to 3. 2. This area is filled with the Kromofon “O” which is made of the CMYK colors of: 0% of cyan, 9% of magenta 15% of yellow, 43% of black. It is identical to 5, 7, 9, 11, and 12. 3. and This area is filled with the Kromofon “S” which is made of the CMYK colors of: 100% of cyan, 0% of magenta, 0% of yellow, and 0% of black. It is identical to 1. 4. This area is filled with the Kromofon “T” which is made of the CMYK colors of: 0% of cyan, 100% of magenta, 0% of yellow, and 0% of black. It is identical to 6. 5. This area is filled with the Kromofon “O” which is made of the CMYK colors of: 0% of cyan, 9% of magenta, 15% of yellow, 43% of black. It is identical to 2, 7, 9, 11, and 12. 6. This area is filled with the Kromofon “T” which is made of the Cow colors of: 0% of cyan, 100% of magenta, 0% of yellow, and 0% of black. It is identical to 4. 7. This area is filled with the Kromofon “O” which is made of the CMYK colors of: 0% of cyan, 9% of magenta, 15% of yellow, 43% of black. It is identical to 2, 5, 9, 11, and 12. 8. This area is filled with the Kromofon “P” which is made of the CMYK colors of: 19% of cyan, 0% of magenta, 91% of yellow, and 0% of black. It is identical to 10. 9. This area is filled with the Kromofon “O” which is made of the CMYK colors of: 0% of cyan, 9% of magenta, 15% of yellow, 43% of black. It is identical to 2, 5, 7, 11, and 12. 10. This area is filled with the Kromofon “P” which is made of the CMYK colors of 19% of cyan, 0% of magenta, 91% of yellow, and 0% of black. It is identical to 8. 11. This area is filled with the Kromofon “O” which is made of the CMYK colors of: 0% of cyan, 9% of magenta, 15% of yellow, 43% of black. It is identical to 2, 5, 7, 9, and 12. 12. This area is filled with the Kromofon “O” which is made of the CMYK colors of: 0% of cyan, 9% of magenta, 15% of yellow, 43% of black. It is identical to 2, 5, 7, 9, and 11.

Searching for words using new directional strategies reveals a number of combinations. Areas 1, 2, and 3 spell out “SOS” clockwise. Areas 3, 2, and 1 spell out “SOS” counterclockwise. Areas 4, 5, 6, 7, or areas 6, 7, 4, 5, or areas 4, 7, 6, 5, or areas 6, 5, 4, 7; can all be used to spell out “TOTO”. These are examples of clockwise and counterclockwise reading. Areas 1, 4, 12, 10, and 3, 6, 11, 8 spell out “STOP”. These are both examples of concentric reading. Reading that is from the outside inwards. Areas 10, 12, 4, 1, and areas 8, 11, 6, 3 spell out “POTS”. These are both examples of centripetal reading. That is from the inside outwards. Areas 8, 9, 10 spell out “POP” reading left to right. Reading areas 10, 9, and 8 also spells “POP” reading right to left.

Using Kromofons, words within word searches can be any size and any shape. Not only does this create unlimited possibilities for online gaming, puzzle makers, game designers and artists, but leads to the addition of new mental strategies in solving problems in the physical plane. For example, this same drawing, not filled in is a Kromofon crossword puzzle.

| | | |
|---|---|---|
| 1. | Clockwise | HELP |
| 2. | Counterclockwise | Oz Dog |
| 3. | Inward | Don't Go |
| 4. | Outward | and pans |
| 4. | Right to Left | Dad |
| 5. | Left to Right | Soda |

Games present ways to enrich our lives by stimulating our minds. Many games use colors to enhance the experience. Kromofons adds meaning to these colors, creating another dimension to gaming. Addition of this extra dimension creates a greater opportunity or children and adults to expand their minds. The most popular written entertainment form is the crossword puzzle. Drawing #5 depicts a crossword puzzle using Kromofons. Current puzzles are limited to linear thinking. Kromofons uses non-linear thinking, expands the use of spatial relationships and fluid reasoning, also known as fit logic.

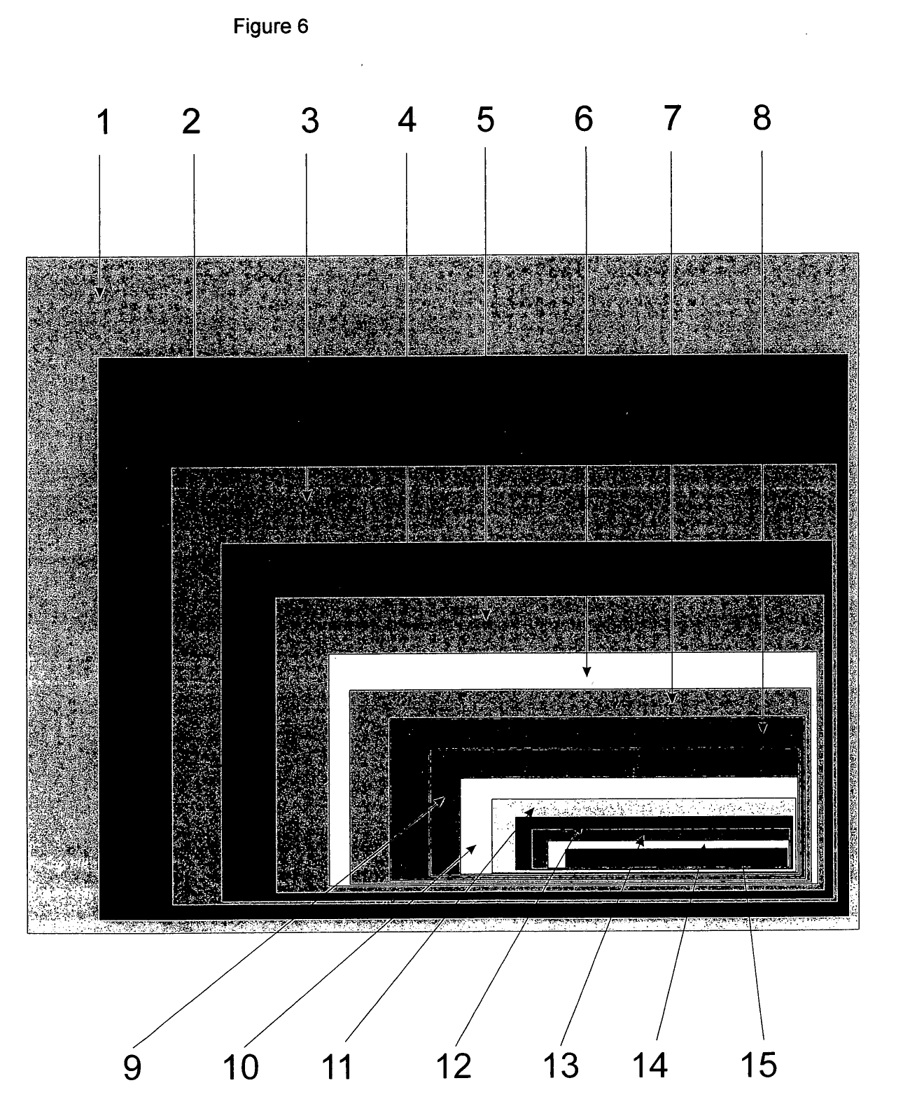

FIG. 6 depicts a group of rectangles inside one another. Each rectangular is filled with a Kromofon. This is read beginning with the outer most rectangle inward. This drawing represents the first in a series of cells that when viewed in rapid succession gives the appearance to the viewer that he is traveling through a tunnel. The blocks originate at the vanishing point, which appears to be the center of the “tunnel”, the furthest distance that can be seen. The tunnel panels show colors progressing outwardly, which visually seems to be towards the viewer. This entire effect is that of traveling thru the text of book or piece of literature. This is one example of a method of animating text.

The colors arising out of the ‘tunnel’ can be associated one to one with an individual typing to their computer then transmitted over the web. This tunnel can be viewed live on a portion of the screen shared with other tunnels creating a new type of chat room, tunneling. Changing the shape of the ‘walls’ as well as the orientation, flowing out, flowing sideways, roller coasting downwards, intertwining snakethreads, all can be the beginning of an entirely new type of human interaction using the web and Kromofons in order to form an elaborate live event.

Animation is the medium and art of bringing to life inanimate objects, and/or giving motion to them. Traditional animation as in Saturday morning cartoons are done thru cel drawings and frame by frame filming. It can also be achieved; by claymation; like Gumby, or by pixellation and computer modeling as in Hollywood special effects. To apply animation to traditional text can make the letters move, but is limited by their forms. If their forms are altered to allow greater movement at some point they lose their recognition value. Kromofons does not sacrifice recognition value when used in an animated mode; in fact, the inventor believes it to be one of its strongest properties.

Applying Kromofons to balls balloons, and other objects allows animated words to be constructed out of virtually any set of objects or materials. Drawing and computer animation techniques used as morphing tools, can take a sequence of defined colors, Kromofons, thru an unlimited number of still or continuous shape changes without changing the meaning of the word from a dictionary standpoint. This adds visual meaning as another level of information. To a limited extent, this, can be applied to multi-layered text. Thus, a poem could consist of one word animating for twenty minutes. Shakespeare's many interpretations on the stage pale to the number of variations Kromanimators will have at their imagination's disposal.

The viewer-reader-observer-consumer's absorption of these new variations on a theme can only be compared to a listener at symphony performed by different artists but written by the same composer.

In FIG. 6 the first word “Kromofons” has nine tunnel panels labeled 1-9. 1. The walls, floor and ceiling that make up the closest section of the tunnel is filled with the character “K” which is printed using the CMYK components: 0% of cyan, 28% of magenta, 6% of yellow, 0% of black. 2. The walls, floor and ceiling that make up the next section of the tunnel is filled with the character “R” which is printed using the CMYK components: 0% cyan, 91% magenta, 100% yellow, 23% black. 3. The next section of the tunnel is filled with the character “O” which is printed using the CMYK components: 0% of cyan, 9% of magenta, 15% of yellow, 43% of black. It is identical to 5 and 7. 4. This section is filled with the character “M” which is painted using the CMYK components: 0% cyan, 94% magenta, 34% yellow, and 28% black. 5. This section is filled with the character “O” which is printed using the CMYK components: 0% of cyan, 9% of magenta, 15% of yellow, 43% of black. It is identical to 3 and 7. 6. This section is filled with the character “F” which is printed using the CMYK components: 0% of cyan, 12% of magenta, 19% of yellow, and 0% of black. 7. This section is filled with the character “O” which is printed using the CMYK components: 0% of cyan, 9% of magenta; 1.5% of yellow, 43% of black. It is identical to 3 and 5. 8. This section is filled with the character “N” which is printed using the CMYK components: 76% cyan, 0% magenta, 100% yellow, and 23% black. 9. This section is filled with the character “S” which is printed using the CMYK components: 100% of cyan, 0% of magenta, 0% of yellow, and 0% of black. Section 10 is white to show the word break. It is identical to 14.

The second word “ARE” has three tunnel panels labeled 11-13. 11. This section is filled with the characters “A” which is printed using the CMYK components: 0% cyan, 0% magenta, 100% yellow, and 19% black. 12. This section is filled with the character “R” which is printed using the CMYK components: 0% cyan, 91% magenta, 100% yellow, and 23% black. It is identical to 2. 13. This section is filled with the character “E” which is printed using the CMYK components: 0% of cyan, 51% of magenta, 87% of yellow, and 0% of black. Section 14 is white to show the word break. It is, identical to 10.

The third word shows only the “T” before it disappears from view labeled 15. 15. This section is filled with the character “T” which is printed using the CMYK components: 0% of cyan, 100% of magenta, 0% of yellow, and 0% of black.

As the story progresses, the “K” shown in 1, moves off the screen and is replaced by the “ER” shown in 2. The “O” and the “M” in succession replace the “R”. This continues as the reader moves into the tunnel, and through the story.

Individuals with partial or total paralysis of neck and/or eye muscles have great difficulty reading current writing systems, whether left to right, right to left, or top to bottom. Kromofons could provide these individuals with the ability to read without moving their head or eyes once their vision is fixed on the center of a monitor by viewing peripherally the color flow.

Animated text, one of the modes that Kromofons can provide, is a continuous stream of colors that in essence moves past the line of sight rather than the current method where the line of sight must scan over the words. Thus the actions of reading becomes passive not active.

Using motion devices that can show perceived motion such as the computer, VCR, CD-ROM, DVD, TV, or film, color streams can move across/through the individual's field of vision, allowing them to read the messages without moving their head and/or eyes and without having to turn pages.

Those people who are legally blind but can still see large areas and distinguish color could open the palette of their personnel reading device in order to choose those colors that they are able to distinguish.

Currently, people with levels of severe far sightedness get so close as to smell the monitor; these people would also benefit from animated moving text.

Current writing systems are confined within the rigid shaped appearance of their characters. Kromofons does not rely on the static forms that the world alphabets do. This independence allows for fluidity and motion of text. We refer to text here in two ways. The first is the visual shape of the text itself, what the word, phrases, sentences, and paragraphs look like; the second is the information contained within the text, the meaning or content. Kromofons text can assume any size, shape, or orientation. This ability allows the animation of the visual shape of the text itself in addition to the ideas contained within.

The observer of animated color streams will comprehend it faster, be able to absorb new styles of concepts, as well as comprehend whole new areas of non-verbal thought. Meaning can be conveyed by temporal relationships, spatial relationships, shape change relationships, and the interaction of any and all of the above.

In the age of the X-Box, where a 10 year old can play their favorite game for ten hours but cannot read one page of a school book without becoming bored, animated text can level the playing field. Injecting color into text creates a medium that is fun. Kromofons creates an exciting new method of reading that is fun. By increasing enjoyment of reading, Kromofons could increase the amount of reading by individuals, leading to, better educated individuals.

Current writing systems are stagnant on a page of text. Readers must interpret the written words into ideas in their minds. The individual's mind holds all images within it. Kromofons adds visual images as additional queues for the viewer. Colors intensify the viewing experience for the individual. Kromofons complements the images created within the viewer's mind with the brilliance of the visual images of the text itself. Drawing #6 displays a method of transforming the written word into an interactive experience through the use of a computer.

In another embodiment a new type of music video will show the words being sung in an animated fashion as part of the entire screen being viewed. This music video could appear on a video monitor, IPOD, a TV or cable station, DVD, or projected by laser lights at a concert. Taken to its extreme, an outdoor concert can have powerful lights projecting words onto clouds.

Interactive reading and writing is also a feature of this invention. As a person is reading a story, he can in real time input new time and motion characteristics of the animated text. This interaction becomes a basis for animated chat rooms on the web.

New neural networks will be built by the generations growing up with ever-changing visual text shapes. Viewing Kromofons will increase the visual memory of color patterns. Kromofon exposure could increase the ability to input simultaneous, related, and divergent stories as well as simultaneous, related, and divergent languages. The creation of new neural pathways is predicted to accommodate the increase in reading speed as well as the features of fluid directionality and connected free-flowing text.

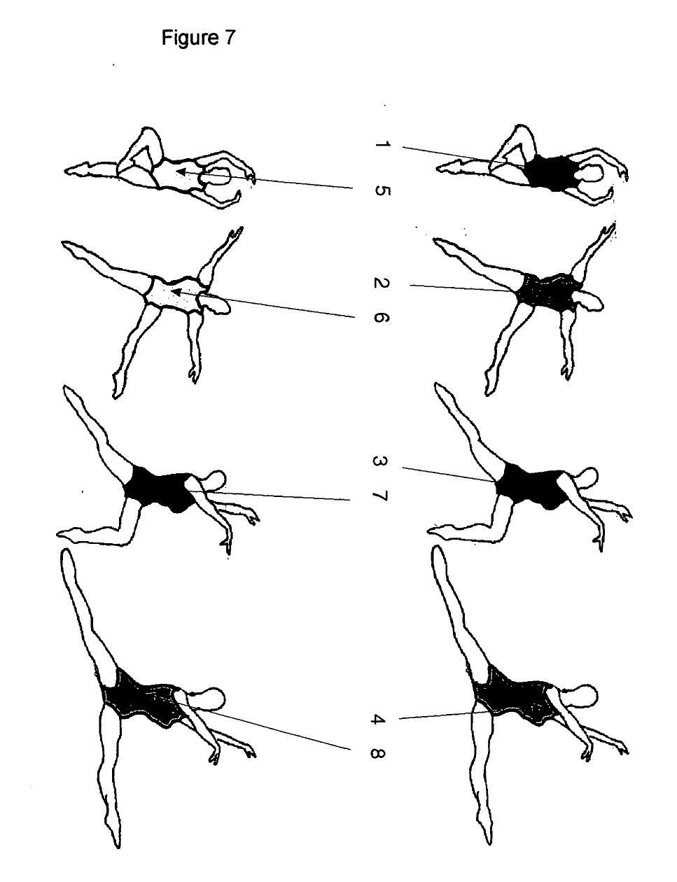

FIG. 7 shows two sets of four performing dancers. Each of the dancers is wearing a white outfit. Color filtered stage lights are pointed at each of the artists, causing the outfits to appear different colors. Each of these colors represents a Kromofons character. Changing the colors of the stage lighting would then change the appearance of the outfits and thus produce new word visual metaphors resulting in true poetry in motion.

The top set of dancers from left to right spell out “LOVE” labeled 1-4. 1. The character “L” contains the CMYK colors of: 0% cyan, 91% magenta, 87% yellow, and 0% black. 2. The character “O” contains the CMYK colors of 0% of cyan, 9% of magenta, 15% of yellow, and 43% of black. 3. The character “V” contains the CMYK colors of: 100% cyan, 79% magenta, 0% yellow, and 0% black. 4. The character “E” contains the CMYK colors of: 0% of cyan, 51% of magenta, 87% of yellow, and 0% of black. It is identical to 8.

The bottom set of dancers from left to right spell out “HATE” labeled 5-8. 5. The character “H”: it is made up of the CMYK colors: 0% cyan, 15% magenta, 94% yellow, 0% black. 6. The character “A”: it is made up of the CMYK colors: 0% cyan, 0% magenta, 100% yellow, 19% black. 7. The character “T”: it is made up of the CMYK colors: 0% cyan, 100% magenta, 0% yellow, 0% black. 8. The character “E” it is made up of the CMYK colors of 0% of cyan, 51% of magenta, 87% of yellow, and 0% of black. It is identical to 4.

These four Kromofon characters form the English word “HATE”. This shows the capability of Kromofons in the arts. Kromofons can enhance the non-verbal messages portrayed by the artists to the audience.

Artists look for new methods of communicating ideas to audiences. The use of Kromofon costumes, props, and stage lighting enhances, by adding information layers, the messages expressed in the performances. Kromofons adds another dimension to intended messages. Entire plays could be performed with and without verbal expression, while using Kromofons in conjunction with costumes, props, scenery, and stage lighting. This use of Kromofons creates an entirely new communication medium for live and recorded entertainment.

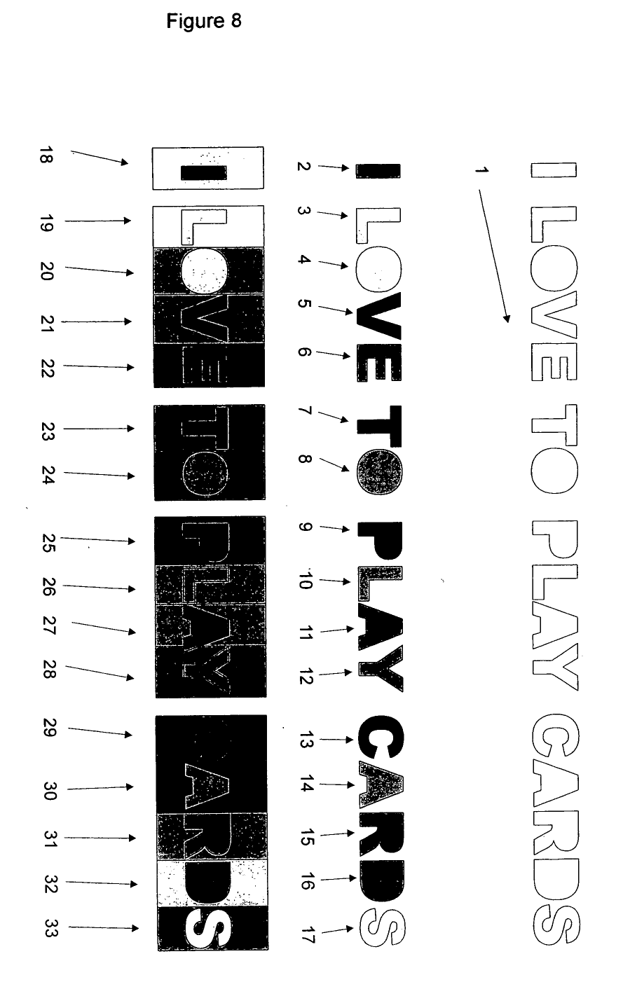

FIG. 8 is an example of three sets of text. The first line contains one set of text, which is depicted in the recognized English alphabet. The second line contains two sets of text. The letters are identical to the first line but are filled in with Kromofons depicting a second set of English text that is not the same as the first. That is to say the letters are not filled with their equivalent Kromofons but rather with a different set and thus with a different meaning. We call this divergent, unilingual writing. The third line in this drawing contains three sets of text. The two previously described becomes the foreground, while a third set of text in Kromofon filled rectangles is used as the background. We call this trivergent, unilingual writing. There, are three different messages within the same language. The foreground and background shapes could also be subdivided and selectively colored thus providing even more information “layers” or infolayering.

The top sentence consists of five words labeled 1. The letters are in a 36 pt serif font. It is read left to right. It is written in traditional English letter forms. The first word is the single letter “I”. It is outlined in black and is filled with white. Since black and white are not colors that are utilized in Kromofons to represent a letter of any alphabet, only one set of text is represented. A space separates words from each other. The complete sentence reads “I LOVE TO PLAY CARDS”.

The second text string that is displayed is in Kromofon filled letter forms. Although the letter forms spell “I LOVE TO PLAY CARDS”, the Kromofon fills do not match the letters and read as an entirely different and separate sentence as well as different and separate words.

Within each of the outlined letters is a color that represents a single Kromofon character in the English alphabet.

The first word “I” is filled with one Kromofon character, or Kromofon labeled 2. 2. The first letter “I” is filled with the Kromofon color that represents the letter “I”. It is printed using the CMYK palette of colors: 100% of cyan, 0% of magenta, 65% of yellow, and 0% of black. It is identical to 23.

The second word “HATE” is made up of the fills of the outlined characters “LOVE” labeled 3-6. Because the word in letters and the word in Kromofons do not match in meaning, we call this divergent text. 3. The first letter outline “L” is filled with the CMYK colors: 0% cyan, 15% magenta, 94% yellow, and 0% black. This color depicts the Kromofon “H”. 4. The second letter outline “O” is filled with 0% cyan, 0% magenta, 100% yellow, 19% black. This coloring characterizes the letter “A”. It is identical to 18. 5. The third letter outline of this word, “V”, is filled with the CMYK values: 0% of cyan, 100% of magenta, 0% of yellow, and 0% of black. This color combination represents the letter “T”. It is identical to 7. 6. The fourth and final letter of the word “LOVE”: “E” is filled with the CMYK values: 0% of cyan, 51% of magenta, 87% of yellow, 0% of black. This Kromofon color is the representation for the letter “E”. It is identical to 12, 16, and 33.

The third word is made up of two outlined characters that are filled with different values of CMYK to represent the word “TO” labeled 7 and 8. 7. The first-letter outlined character “T” is filled with 0% of cyan, 100% of magenta, and 0% of yellow, 0% of black; This color depicts the Kromofon “T”. It is identical to 5. 8. The second letter, the English character “O” is filled with 0% of cyan, 9% of magenta, and 15% of yellow, 43% of black. This represents the Kromofon “O”. It is identical to 10, 14, 20, 21, 26, 27, and 31.

The fourth word in letterforms “PLAY” is made up of four Kromofon fills that spell “LOSE” labeled 9-12. 9. The first letter outlined character “P” is filled with 0% cyan, 91% magenta, 87% yellow, and 0% black. This color depicts the Kromofon “L”. It is identical to 22. 10. The second letter “L” is filled with 0% of cyan, 9% of magenta, and 15% of yellow, 43% of black. This coloring characterizes the Kromofon “O”. It is identical to 8, 14, 20, 21, 26, 27, and 31. 11. The third letter of this word, “A”, is filled with the CMYK values: 100% of cyan, 0% of magenta, 0% of yellow, and 0% of black. This combination of color ink values represents the Kromofon “S”. It is identical to 24 and 25. 12. The fourth letter of this word, “Y”, is filled with the CMYK values: 0% of cyan, 51% of magenta, 87% of yellow, and 0% of black. This is the Kromofon “E”. It is identical to 6, 16, and 33.

The fifth word “CARDS” is Kromofon filled to spell “MONEY” labeled 13-17. 13. The first letter outlined character “C” is filled with 0% cyan, 94% magenta, 34% yellow, and 28% black. This color depicts the letter “M”. 14. The second letter, the English character “A” is filled with 0% of cyan, 9% of magenta, and 15% of yellow, 43% of black. This coloring characterizes the Kromofon “O”. It is identical to 8, 10, 20, 21, 26, 27, and 31. 15. The third letter of this word, “R”, is filled with 76% of cyan, 0% of magenta, 100% of yellow, and 23% of black. This printing combination represents the Kromofon “N”. It is identical to 28. 16. The fourth letter outlined character “D” is filled with 0% of cyan, 51% of magenta, 87% of yellow, and 0% of black. This is the Kromofon “E”. It is identical to 6, 12, and 33. 17. The fifth letter “S” is the Kromofon “Y”. The printed components are 38% cyan, 0% magenta, 38% yellow, and 0% black.

The whole English text reads “I LOVE TO PLAY CARDS”. The whole Kromofon sentence reads “I HATE TO LOSE MONEY”. The third row in this drawing has a fore and back ground. The third text string is located in the background. It is a series of Kromofon filled blocks. The foreground is equivalent to the second row in this drawing. It is letter outlined and Kromofon filled. All three sentences are different, making this an example of trivergent text.

The first background word “A” is made up of one Kromofon block. The foreground contains the letter form word “I”; Kromofon filled with “I” labeled 18. Block #18 is the Kromofon “A” printed using the CMYK components: 0% cyan, 0% magenta, 100% yellow, and 19% black. It is identical in color to 4.

The second background word “FOOL” is made up of four Kromofon blocks. The foreground contains the letterform word “LOVE”; Kromofon filled with “HATE” labeled 19-2. Block #19 is the Kromofon “F” printed using the CMYK components: 0% of cyan, 12% of magenta, 19% of yellow, and 0% of black. Block #20 is the Kromofon “O” printed using the CMYK components: 0% of cyan, 9% of magenta, 15% of yellow, and 43% of black. It is identical to 8, 10, 14, 21, 26, 27, and 31. Block #21 is the Kromofon “O” printed using the CMYK components: 0% of cyan, 9% of magenta, 15% of yellow, and 43% of black. It is identical to 8, 10, 14, 20, 26, 27, and 31. Block #22 is the Kromofon “L” printed using the CMYK components: 0% cyan, 91% magenta, 87% yellow, and 0% black. It is identical to 9.

The third background word “IS” is made up of two Kromofon blocks. The foreground contains the letter forms word “TO”, Kromofon filled with “TO” labeled 23 and 24. Block #23 is the Kromofon “I” printed using the CMYK components: 100% of cyan, 0% of magenta, 65% of yellow, and 0% of black. It is identical to 2. Block #24 is the Kromofon “S” printed using the CMYK components: 100% of cyan, 0% of magenta, 0% of yellow, and 0% of black. It is identical to 11 and 25.

The fourth background word “SOON” is made up of four Kromofon blocks. The foreground contains the letterform word “PLAY”; Kromofon filled with “LOSE”. Block #25 is the Kromofon “S” printed using the CMYK components: 100% of cyan, 0% of magenta, 0% of yellow, and 0% of black. It is identical to 11 and 24. Block #26 is the Kromofon “O” printed using the CMYK components: 0% of cyan, 9% of magenta, 15% of yellow, and 43% of black. It is identical to 8, 10, 14, 20, 21, 27, and 31. Block #27 is the Kromofon “O” printed using the CMYK components: 0% of cyan, 9% of magenta, 15% of yellow, and 43% of black. It is identical to 8, 10, 14, 20, 21, 26, and 31. Block #28 is the Kromofon “N” printed using the CMYK components: 76% of cyan, 0% of magenta, 100% of yellow, and 23% of black. It is identical to 15.

The fifth background word “BROKE” is made up of five Kromofon blocks. The foreground contains the letterforms word “CARDS”; Kromofon filled with “MONEY” labeled 29-33. Block #29 is the Kromofon “B” printed using the CMYK components: 23% of cyan, 56% of magenta, 0% of yellow, and 0% of black. Block #30 is the Kromofon “R” printed using the CMYK components: 12% of cyan, 48% of magenta, 0% of yellow, and 40% of black. Block #31 is the Kromofon “O” printed using the CMYK components: 0% of cyan, 9% of magenta, 15% of yellow, and 43% of black. It is identical to 8, 10, 14, 20, 21, 26, and 27. Block #32 is the Kromofon “K” printed using the CMYK components: 0% of cyan, 28% of magenta, 6% of yellow, and 0% of black. Block #33 is the Kromofon “E” printed using the CMYK colors of 0% of cyan, 51% of magenta, 87% of yellow, and 0% of black. It is identical to 6, 12, and 16.

These five Kromofon characters form the English word “BROKE”. The background sentence reads, “A FOOL IS SOON BROKE”. All three sentences can therefore be read on the same line, “I LOVE TO PLAY CARDS”, “I HATE TO LOSE MONEY”, and “A FOOL IS SOON BROKE”;

The third line of FIG. 8 is an example of Kromofons used to display a trivergent, unilingual message. Current writing systems allow only one message to be displayed in the special area allotted for it. Kromofons, in its multi-layered mode, can create multiple messages occupying the same area. FIG. 8 shows how Kromofons is used to maximize space by conveying three sets of information. Each of the messages is independent of one another and can be read individually. This use of divergent and trivergent messages can be used in puzzles, games, or creative sayings.

A mystery novel could be produced that follows three characters simultaneously. The standard letterforms could follow the butler into the study. The Kromofon fill within those letterforms describes the actions of the maid in the upstairs bedroom. A third story line following the cook is read from the background Kromofon fill. This use of Kromofons could revolutionize writing in general, and mysteries in particular. New literary mediums flow out of the use of two, or three layers and how they relate or not relate to each other contextually. New mediums stimulates new thought and in this instances new styles of thought.

Advertisers maximizing space allotted for messages can minimize cost while tripling information by using multi-layered Kromofons. This use of divergent and trivergent messages will increase the effectiveness of advertising, labeling, product information, signs, and any medium in a confined space used to convey needed info.

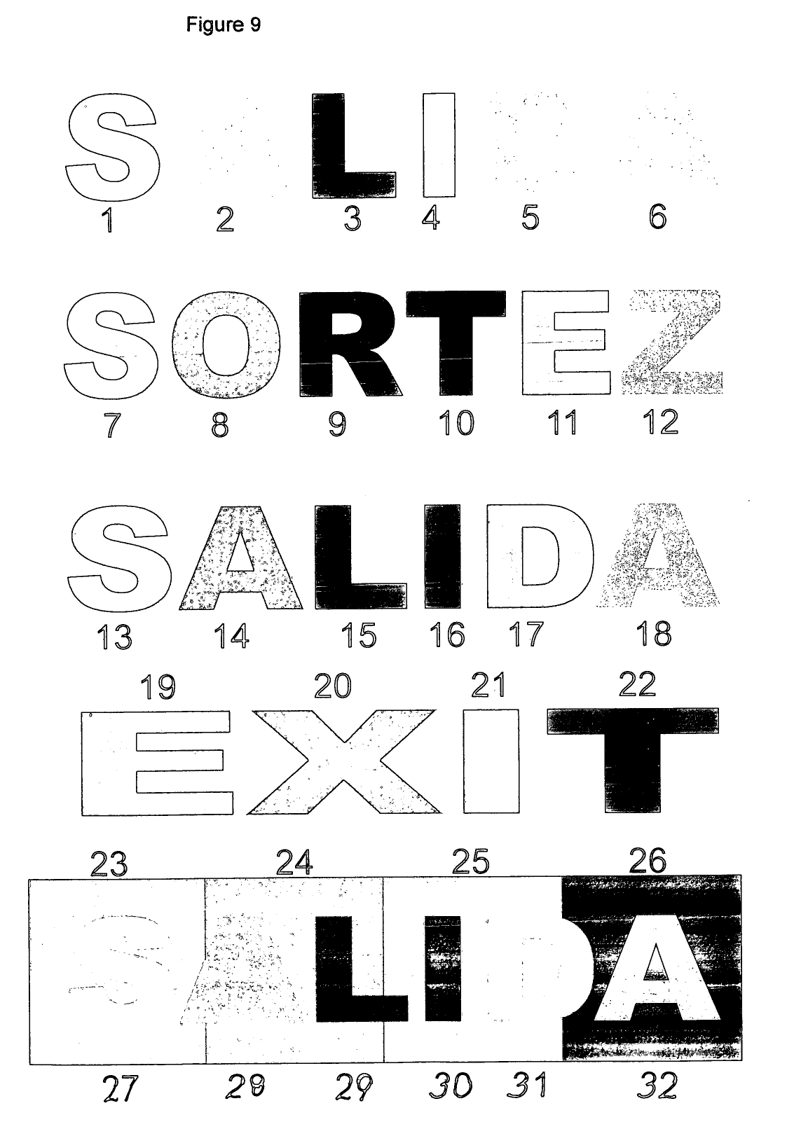

FIG. 9 is an example of convergent bilingual and trilingual writing. The first word shown is made of six characters labeled 1-6. The word “SALIDA” is written in Spanish letterforms. The Kromofons within these letterforms represent the same Spanish letters and therefore the same word, “SALIDA”. This is convergent, unilingual text. That is multi-layered text with the same meaning but in two languages.

1. The first letter “S” contains the CMYK colors of: 100% of cyan, 0% of magenta, 0% of yellow, and 0% of black. This Kromofons combination represents the Spanish letter “S”. It is identical to 13, and 277, 13, and 27. 2. The second letter “A” contains the CMYK colors of 0% cyan, 0% magenta, 100% yellow, and 19% black. This Kromofons combination represents the Spanish letter “A”. It is identical to 6. 3. The third letter “L” contains the CMYK colors of: 0% cyan, 91% magenta, 87% yellow, and 0% black. This Kromofons combination represents the Spanish letter “L”. 4. The fourth letter “I” contains the CMYK colors of 100% cyan, 0% magenta, 65% yellow, and 0% black. This Kromofons combination represents the Spanish letter “I”. 5. The fifth letter “D” contains the CMYK colors of 28% cyan, 0% magenta, 12% yellow, and 0% black. This Kromofons combination represents the Spanish letter “D”. 6. The sixth letter “A” contains the CMYK colors of 0% of cyan, 0% of magenta, 100% of yellow, and 19% of black. This Kromofons combination represents the Spanish letter “A”. It is identical to 2.

The second word shown is made of six characters. It is the French word “SORTEZ” labeled 7-12. The Kromofon fill of these letters match or represent the same. French letters. The Kromofon French word is also “SORTEZ”. This is a second example of convergent, unilingual text. 7. first letter “S” contains the CMYK colors of: 100% of cyan, 0% of magenta, 0% of yellow, and 0% of black. This Kromofons combination represents the French letter “S”. It is identical to 1, 13, and 27. 8. The second letter “O” contains the CMYK colors of 0% of cyan, 9% of magenta, 15% of yellow, and 43% of black. This Kromofons combination represents the French letter “O”. It is identical to 14, and 28. 9. The third letter “R” contains the CMYK colors of: 0% cyan, 91% magenta, 100% yellow, and 23% black. This Kromofons combination represents the French letter “R”. It is identical to 15, and 29. 10. The fourth letter “T” contains the CMYK colors of: 0% of cyan, 100% of magenta, 0% of yellow, and 0% of black. This Kromofons combination represents the French letter “T”. It is identical to 16, 22, 26 and 30. 11. The fifth letter “E” contains the CMYK colors of: 0% of cyan, 51% of magenta, 87% of yellow, and 0% of black. This Kromofons combination represents the French letter “E”. It is identical to 17, 19, 23, and 31. 12. The sixth letter contains the CMYK colors of 0% of cyan, 0% of magenta, 47% of yellow, and 31% of black. This Kromofons combination represents the French letter “Z”. It is identical to 18 and 32.

The third word shown is made of six characters. The letterforms spell out “SALIDA”, which is “exit” in Spanish. The Kromofon fills in this instance do NOT match their respective letterforms. The Kromofons used to fill the letterforms represent the French word “SORTEZ”, which also means “exit”. This is a convergent, bilingual word. That is the use of two words in two languages with the same meaning represented on the space that is traditionally used for a single word in one single language.

13. The first Spanish letter “S” contains the CMYK colors of: 100% of cyan, 0% of magenta, 0% of yellow, and 0% of black. This Kromofons combination represents the French letter “S”. It is identical to 1, 7 and 27. 14. The second Spanish letter “A” contains the CMYK colors of 0% of cyan, 9% of magenta, 15% of yellow, and 43% of black. This Kromofons combination represents the French letter “O”. It is identical to 8 and 28. 15. The third Spanish letter “L” contains the CMYK colors of: 0% cyan, 91% magenta, 100% yellow, and 23% black. This Kromofons combination represents the French letter “R”. It is identical to 9 and 29. 16. The fourth Spanish letter “I” contains the CMYK colors of 0% of cyan, 100% of magenta, 0% of yellow, and 0% of black. This Kromofons combination represents the French letter “T”. It is identical to 10, 22, 26, and 30. 17. The fifth Spanish letter “D” contains the CMYK colors of 0% of cyan, 51% of magenta, 87% of yellow, and 0% of black. This Kromofons combination represents the French letter “E”. It is identical to 11, 19, 23, and 31. 18. The sixth Spanish letter “A” contains the CMYK colors of 0% of cyan, 0% of magenta, 47% of yellow, and 31% of black. This Kromofons combination represents the French letter “Z”. It is identical to 12 and 32.

The fourth word shown “EXIT” is made up of four English standard letterform characters labeled 19-22. The Kromofon fills within the letterforms represent the same letters as the letterforms; therefore the English Kromofon word is also “EXIT”. This is another example of convergent, unilingual text. 19. The first letter “E” contains the CMYK colors of: 0% of cyan, 51% of magenta, 87% of yellow, and 0% of black. This Kromofons combination represents the English letter “E”. It is identical to 11, 17, 23 and 31. 20. The second letter “X” contains the CMYK colors of 0% of cyan, 0% of magenta, 0% of yellow, and 56% of black. This Kromofons combination represents the English letter “X”. It is identical to 24. 21. The third letter “I” contains the CMYK colors of: 100% of cyan, 0% of magenta, 65% of yellow, and 0% of black. This Kromofons combination represents the English letter “I”. It is identical to 25. 22. The fourth letters contains the CMYK colors of 0% of cyan, 100% of magenta, 0% of yellow, and 0% of black. This Kromofons combination represents the English letter “T”. It is identical to 10, 16, 26 and 30.

The last line shown has all three languages displayed within the same space labeled 23-26. The Kromofon filled background-blocks represent the English word “EXIT”. The foreground is made of “SALIDA” and “SORTEZ”. In letter form, the Spanish word “SALIDA” is written. The Kromofon fills within “SALIDA” are the French word “SORTEZ”. This is an example of convergent trilingual text. That is three words from three different languages all with the same meaning occupying the same visual space that now can only contain one language and one word.

The maximum quantity of layers that a human can follow or a machine scan has not yet been determined. Experimentally, we have achieved 15 but for the purposes of this application it is enough to show that multiple layers are easily possible and distinguishable. Imagine an EXIT sign in a London Railroad station. Trilingual messages of English, Spanish, and French can be placed onto that same sign as follows. 23. The first block contains the CMYK colors of 0% of cyan, 51% of magenta, 87% of yellow, and 0% of black. This Kromofons combination represents the English letter “E”. It is identical to 11, 17, 19 and 31. 24. The second block contains the CMYK colors of 0% of cyan, 0% of magenta, 0% of yellow, and 56% of black. This Kromofons combination represents the English letter “X”. It is identical to 20. 25. The third block contains the CMYK colors of 100% of cyan, 0% of magenta, 65% of yellow, and 0% of black. T his Kromofons combination represents the English letter “I”. It is identical to 21. 26. The fourth block contains the CMYK colors of 0% of cyan; 100% of magenta, 0% of yellow, and 0% of black. This Kromofons combination represents the English letter “T”. It is identical to 10, 16, 22 and 30. These four Kromofon blocks form the English word “EXIT” in the background. The Kromofon fill within the letterforms represent the French text “SORTEZ”. The Spanish letters in the foreground spell “SALIDA”. Together these bilingual words represent the foreground. 27 is identical to 13. 28 is identical to 14. 29 is identical to 15. 30 is identical to 16. 31 is identical to 17. 32 is identical to 18.

Thus FIG. 9 displays Kromofons usage in international environments. Areas such as Europe, which have a wide variety of languages in a relatively small area, could use Kromofons to create multi-lingual signs for travelers. Since many of a foreign traveler's difficulties arise in relation to a lack of understanding of the language of the host country or region, this use of multi-lingual Kromofon signs would put the traveler more at ease and may result in a greater tourist trade for these areas.

A commercial advantage would be to produce a package printed in two or more languages simultaneously. This would save time and money in the printing, shipping, and stocking of the product, as well as reduce the necessary shelf space. An example would be two identical cereal boxes written in English and Spanish, as is found in many grocery stores. Using Kromofons, the multi-lingual messages are conveyed within the same spatial area on the packaging and for a single language's message, this reduces the total amount of store inventory of each product. English standard letter forms would display the message for the English speaking population, while Kromofon characters, inside of the outlined English text, would relate the message for the secondary language speaking population, such as Spanish.

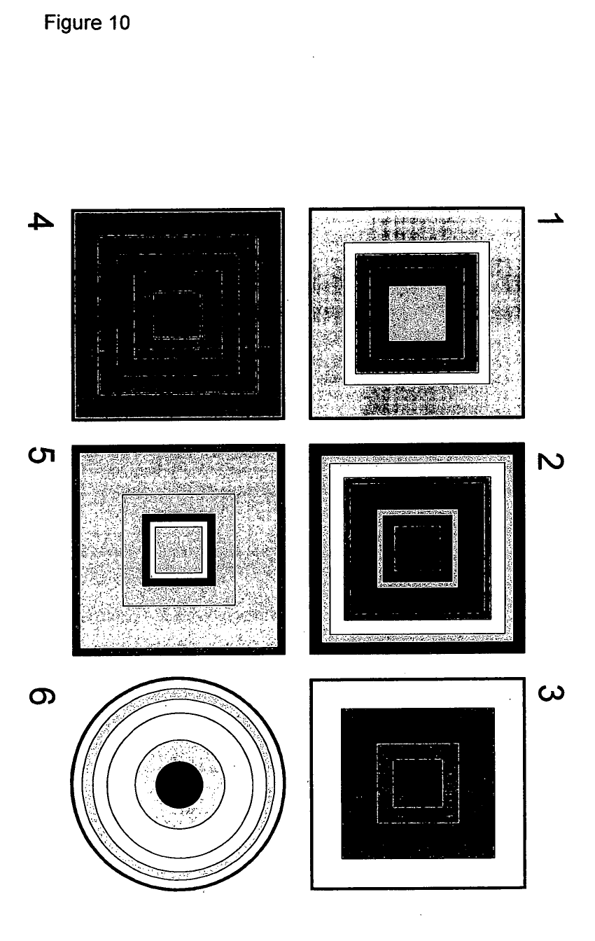

FIG. 10 is a snapshot from an Internet chat room in 2-D with motion. It represents 6 people discussing an upcoming concert. Each square represents one individual's input. Each square is a tunnel in motion continually showing in an animated form the Kromofon characters flowing in or out of the tunnel. The direction of the tunnel, in fact the very shape of the tunnel can be determined by the writer, the reader, or both depending on their Kromofon chatware.

Inputting through a person's computer hookup may consist of pasting previous text, typing live, or by speech recognition or some other modality designed to capture their words. The personal thoughts are thus being transmitted visually to the chat room. In its advanced form the text will almost come alive and interact with other text like two snakes wrapped around each other or other graphical metaphors being evolved.

The participants are labeled 1-6. Participants one through five choose the form of a square with flowing tunnels. Number 6 choose to shape the tunnel as round. Tunnels 1, 2, 3, 4, and 6 flow from the inside outwards. Tunnel number 5 flows from the outside inwards. Tunnel #1 starts ARE YOU. Tunnel #2 reads STARTS AT. Tunnel #3 spells out WOW. Tunnel #4 replies CONCERT. Tunnel #5 says WHAT ARE. Tunnel #6 reveals MY DAD.

A variety of other animated features create spatial relationships and visual interplays allowing for conversational threading, the interweaving of various conversations into new thought forms. A 3D version is difficult to portray on a single diagram. The combination of motion and direction, object and speed, all Kromofon sequenced, provides endless visual combinations and streams representing the thoughts of multiple individuals visually interacting on one's monitor.

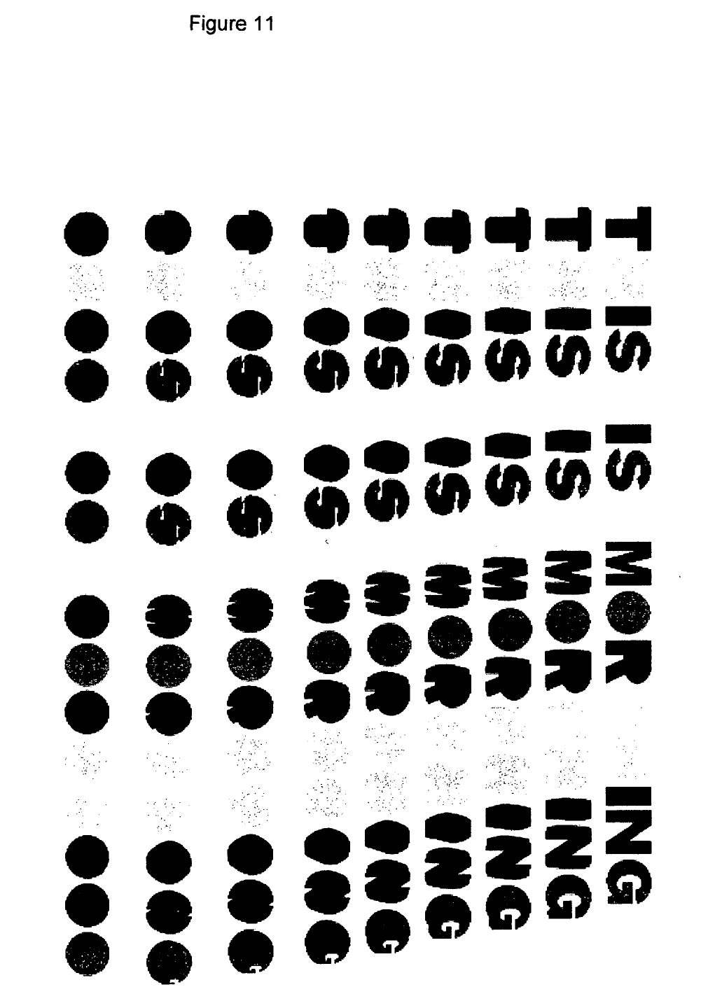

FIG. 11 speaks for itself. It spells correctly, “THIS IS MORPHING.” Over the course of eight transitions the letters become colormorphs. This is called interdimensional shifting from the text to the color in a short transforming process filled with consistent colors. A book or short story would be read without slowing down and the repetition combined with the slow dissolving of one of the two visual queues forces the brain to slowly acquire a new set of visual marks, those being that of color, while not slowing down the process of reading is a self reinforcing painless effortless way to train the brain for viewing the new medium of Kromofons.

In today's growing global society, an individual has a greater opportunity to encounter cultures different from their own. Individuals need the ability to communicate with other cultures and to interact in those environments. Since alphabets are the visual representation of language, knowing another alphabet enhances the opportunity to communicate.

Kromofons can be used as a visual bridge in the gap between two alphabets, creating a greater chance at understanding other cultures.

A method of using Kromofons to teach other languages would be to have standard letterforms from the student's native alphabet transmorph into a Kromofon character representing that letter. This Kromofon would then progress through its transmorph into the standard letterform of the second language's alphabet being learned.

An advantage Kromofons has, which previous attempts at a universal alphabet lacked, is that Kromofons does not compete with the imbedded alphabet shapes of the language of another cultures' writing systems.

Individuals should be able to utilize Kromofons to learn foreign languages quicker and easier then conventional methods. This global understanding of cultures should lead to more significant and successful interaction between different peoples and cultures.

Although this invention has been described in connection with specific forms and colors thereof, it is understood appreciated that a wide array of equivalents may be substituted for the specific elements or colors shown and described herein without departing from the spirit and scope of this invention as described in the appending claims.

What is claimed is:

1. An information delivery system comprising characters, symbols or elements of an alphabet that are each represented by different colored areas or objects such that a group of said colored areas or objects communicate words or sentences.

2. The information delivery system of claim 1 further comprising colored areas or objects that are produced by media such as animation, computer imaging, printing, drawing, light reflection, and holograms.

3. The information delivery system of claim 2 further comprising colored areas or objects that are produced in a sequential manner.

4. The information delivery system of claim 1 wherein the alphabet is the English alphabet.

5. The information delivery system of claim 1 wherein the alphabet is the International Phonetic Alphabet.

6. The information delivery system of claim 1 further comprising colored areas or objects that are each in the shape of said alphabet characters, symbols or elements represented by said colored areas or objects.

7. The information delivery system of claim 1 further comprising colored areas or objects that are each in a shape different from said alphabet characters, symbols or elements represented by said colored areas or objects.

8. The information delivery system of claim 1 further comprising alphabet characters, symbols or elements that are each placed in said colored areas or objects.

9. The information delivery system of claim 8 further comprising alphabet characters, symbols or elements that are each placed in said colored areas or objects representing said alphabet characters, symbols or elements.

10. The information delivery system of claim 8 further comprising alphabet characters, symbols or elements that are each placed in said colored areas or objects not representing said alphabet characters, symbols or elements.

11. A information delivery system for educating people by communicating information in the form of colored areas or objects each representing alphabet characters, symbols or elements.

12. The information delivery system of claim 11 further comprising colored areas or objects that are used to train someone who can read one language to read another language.

13. The information delivery, system of claim 11 further comprising colored areas or objects that are initially shaped in the form of alphabet characters, symbols or elements represented by said colored areas or objects, said colored areas or objects changing shape to a shape different from the shape of said alphabet characters, symbols or elements represented by said colored areas or objects.

14. An information delivery system for entertaining people comprising colored areas or objects representing alphabet characters, symbols or elements which are placed on entertainment articles such as games, books, puzzles, video screens, dancers, performers, props, costumes, scenery, and curtains.

15. A method for information delivery comprising using specific sequences of colored areas or objects to represent a word.
